(19) United States
(12) Patent Application Publication
(10) Pub. No.: US 2021/0276166 A1
(43) Pub. Date: Sep. 9, 2021

(54) RATCHET WRENCH

(71) Applicant: Yi-Fu Chen, Taichung City (TW)

(72) Inventor: Yi-Fu Chen, Taichung City (TW)

(21) Appl. No.: 16/809,562

(22) Filed: Mar. 5, 2020

(51) Int. Cl. B25B 23/00; B25B 13/46

(52) U.S. Cl. CPC B25B 23/0028; B25B 13/481; B25B 13/461; B25B 23/0035

(57) ABSTRACT

A ratchet wrench includes two arms extending from one end of the handle, and a head is pivotably connected between the two arms. The head includes a first connection portion and a second connection portion respectively formed to two opposite sides of the head so as to be connected with a pivotable member such as a socket or a bit as needed. The head is pivotable relative to the two arms, and the pivotable member is pivotable relative to the head. The ratchet wrench is able to be used in different angles and positions.

### BACKGROUND OF THE INVENTION

### 1. Fields of the invention

The present invention relates to a ratchet wrench, and more particularly, to a ratchet wrench that is able to use in different angles.

### 2. Descriptions of Related Art

The conventional ratchet wrenches are developed and used for a long period of time, and include many different types to meet different requirements of the users. The ratchet mechanism allows the ratchet wrench to be rotated back and forth without removing the ratchet wrench from the object.

However, the users need a ratchet wrench that has more flexibility to be used in different angles and directions.

The present invention intends to provide a ratchet wrench that has a pivotable head to which two different connection portions are formed to two opposite sides of the head so as to eliminate the shortcomings mentioned above.

### SUMMARY OF THE INVENTION

The present invention relates to a ratchet wrench and comprises a handle having a first end and a second end. Two arms extend from the second end of the handle, and a room is formed between the two arms. A head is pivotably connected between the two arms and pivotable relative to the two arms. The head has a first connection portion formed to a first side thereof. The first connection portion has a reception hole defined in a distal end thereof. A pivotable member is removably connected to the first connection portion and has a multiple-face part, a driving end and a neck which is formed between the multiple-face part and the driving end. The multiple-face part is pivotably inserted into the reception hole so that the pivotable member is pivotable relative to the head. A control unit is mounted to outside of the first connection portion and controls engagement and removal of the multiple-face part relative to the reception hole.

The advantages of the present invention is that the head is pivotable between the two arms, and the pivotably member connected to the first connection member of the head is pivotable as well, so that a bit for example connected to the pivotable member can reach an object that is not easily accessed by using conventional tool.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the ratchet wrench of the present invention;

FIG. 2 is an exploded view of the ratchet wrench of the present invention;

FIG. 3 is an exploded view of the ratchet wrench of the present invention;

FIG. 4 is a cross sectional view, taken along line IV-IV in FIG. 1;

FIG. 5 is a cross sectional view to show that the head is pivoted;

FIG. 5A is a cross sectional view to show that the head is pivoted and the second connection portion does not hit the arms;

FIG. 6 shows that the pivotable member connected to the head is pivoted;

FIG. 7 shows that the head in FIG. 6 is pivoted;

FIG. 8 is a perspective view to show the second embodiment of the ratchet wrench of the present invention;

FIG. 9 is an exploded view of the second embodiment of the ratchet wrench of the present invention;

FIG. 10 is a cross sectional view, taken along line X-X in FIG. 8;

FIG. 11 shows that the collar in FIG. 10 is slid and the pivotable member is removed from the first connection member;

FIG. 12 shows that the head in FIG. 10 is pivoted;

FIG. 13 shows that the pivotable member in FIG. 10 is pivoted relative to the first connection portion, and

FIG. 14 shows that the two arms are integrally formed with the handle of the ratchet wrench of the present invention.

### DETAILED DESCRIPTION OF THE PREFERRED EMBODIMENT

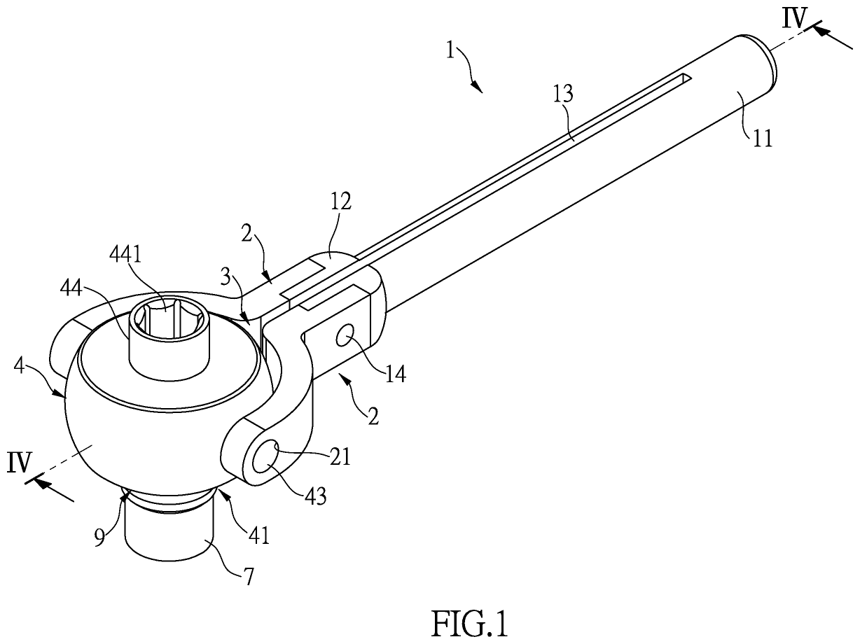

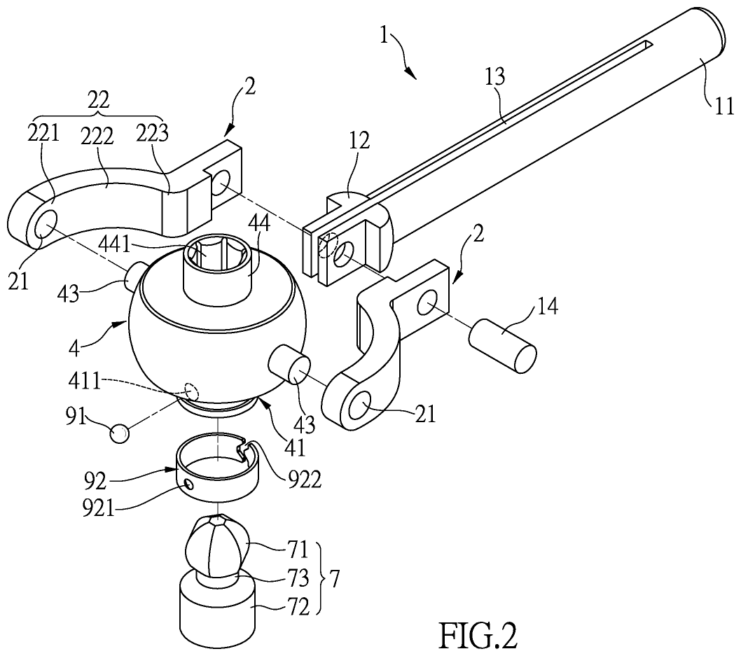

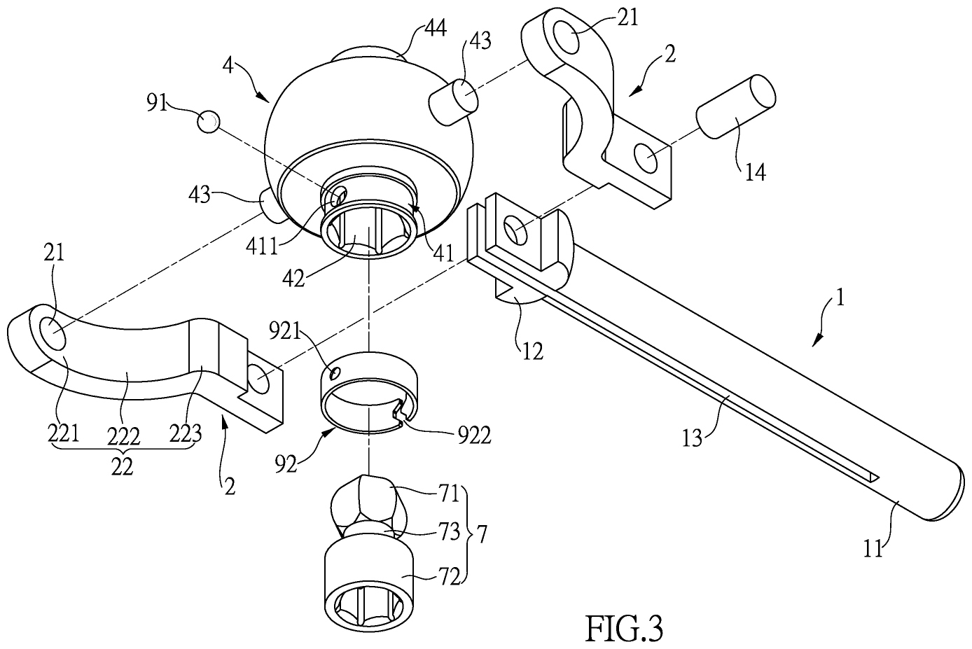

Referring to FIGS. 1 to 7, the ratchet wrench of the present invention comprises a handle 1 having a first end which is a grip end, and a second end which is an operation end 12. Two arms 2 extend from operation end 12 of the handle 1 and form a Y-shaped arrangement. A room 3 is formed between the two arms 2. A head 4 is pivotably connected between the two arms 2 and is pivotable relative to the two arms 2. Specifically, the head 4 has a first connection portion 41 formed to the first side thereof, and the first connection portion 41 has a reception hole 42 defined in the distal end thereof. Two pivots 43 respectively extend diametrically from outside of the head 4. The head 4 includes a second connection portion 44 formed to the second side of the head 4. The second connection portion 44 is located opposite to the first connection portion 41. The second connection portion 44 has a second reception hole 441. As shown in FIG. 1, the two arms 2 each have a straight section and a curved section. The curved section includes an inner face 22 which includes a first curved section 221, a second curved section 222 and a connection section 223. A bore 21 is defined through each arm 2 and located corresponding to the first curved section 221. A through hole is defined through the straight section. The two pivots 43 extend through the two respective bores 21 of the first curved sections 221 of the two arms 2. A slot 13 a slot 13 is defined axially in the operation end 12 and extends a distance along the handle 1.

The slot 13 communicates through the distal end of the operation end 12. A pin 14 extends through the two holes and the operation end 12 of the handle 1 to connect the two arms 2 to the operation end 12. Preferably, the curvature of the first curved section 221 is smaller than that of the second curved section 222. The connection section 223 avoids the head 4 to hit the two arms 2 when the head 4 is pivoted.

A pivotable member 7 is removably connected to the first connection portion 41 and includes a multiple-face part 71, a driving end 72 and a neck 73 which is formed between the multiple-face part 71 and the driving end 72. The multiple-face part 71 is pivotably inserted into the reception hole 42 so that the pivotable member 7 is pivotable relative to the head 4 about the multiple-face part 71. The driving end 72 is a socket to be connected with a bit (not shown) for example.

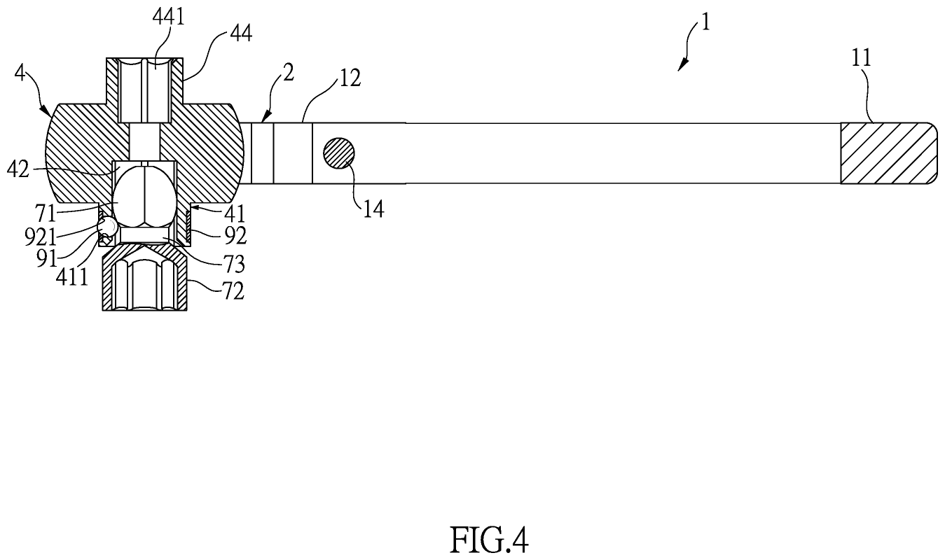

A control unit 9 is mounted to outside of the first connection portion 41 and controls engagement and removal of the multiple-face part 71 relative to the reception hole 42. Specifically, the control unit 9 includes a first ball 91 and an expandable member 92. The expandable member 92 is a C-shaped member and includes a restriction hole 921 defined through the wall thereof. An opening 922 is formed between two distal ends of the expandable member 92. The first connection portion 41 includes a first hole 411 defined through the wall thereof. The first hole 411 communicates with the first reception hole 42. The first hole 411 is located corresponding to the restriction hole 921. The first ball 91 is engaged with the first hole 411 and has a portion protruding beyond the first hole 411. The portion of the first ball 91 that protrudes beyond the first hole 411 is pushed by the periphery of the restriction hole 921 to partially protrude into the first reception hole 42. As shown in FIG. 4, when the multiple-face part 71 is inserted into the first reception hole 42, the first ball 91 is pushed outward by the multiple-face part 71 to expand the expandable member 92 by widening the opening 922 so that the multiple-face part 71 can be successfully inserted into the first reception hole 42. The first ball 91 is then engaged with the neck 73 when the multiple-face part 71 passes the first ball 91 to position the pivotable member 7 in the first reception hole 42.

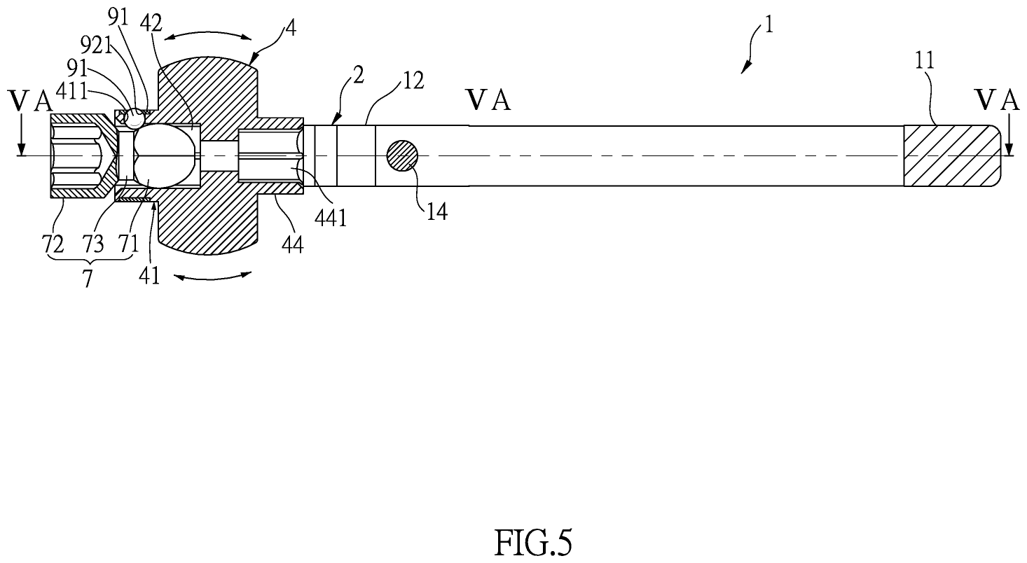

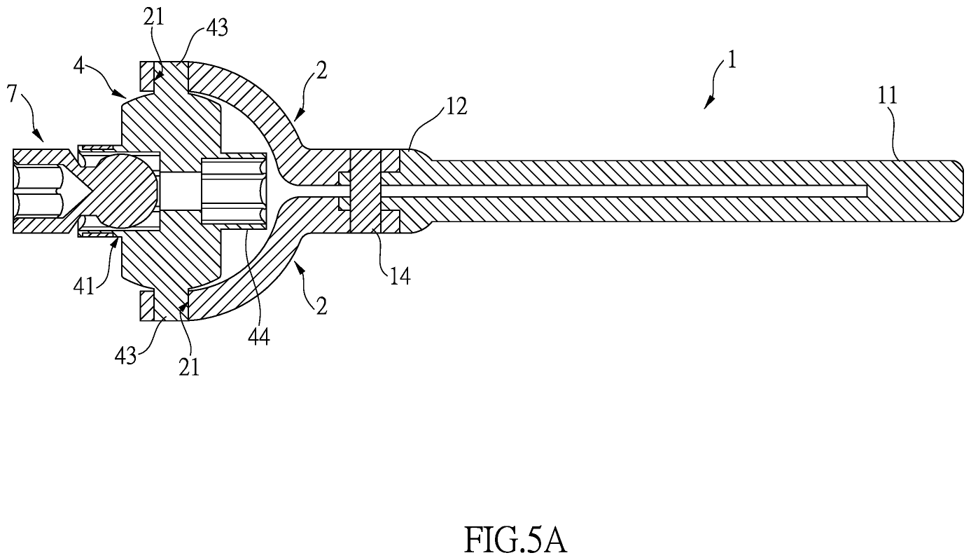

As shown in FIG. 5A, the head 4 is pivoted, when the pivotable member 7 is removed from the first connection portion 41, the second connection portion 44 does not hit the arms 2.

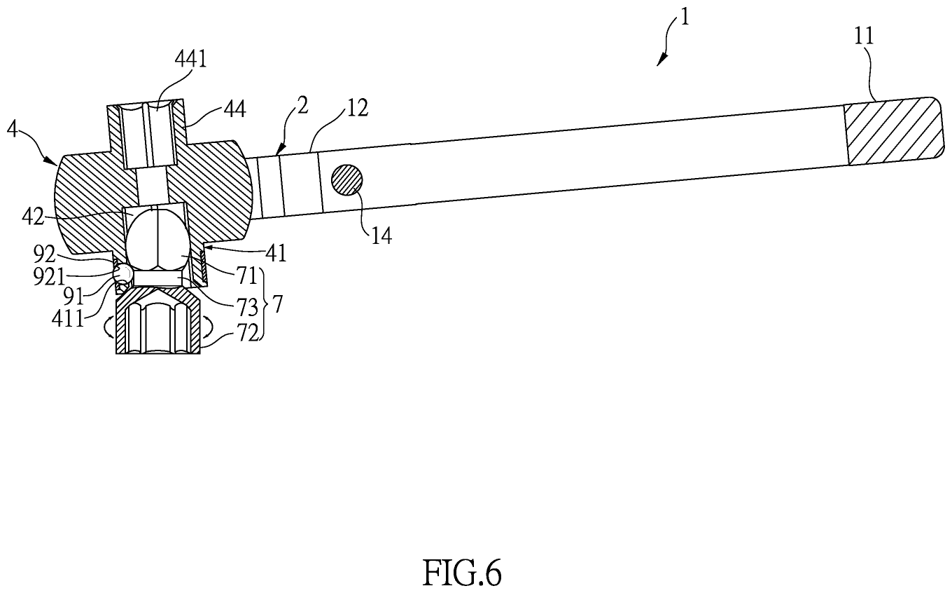

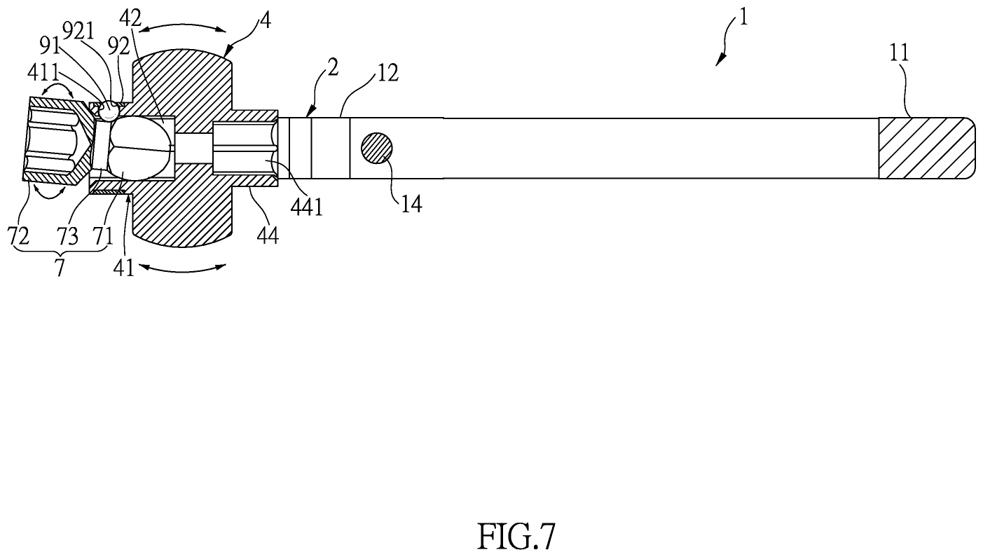

As shown in FIG. 6, the multiple-face part 71 is pivotable relative to the first reception hole 42, so that the bit (not shown) connected to the driving end 72 can angularly access an object (not shown). FIG. 5 shows that the head 4 is pivoted about the pivots 43 to locate the pivotable member 7 in the axial direction of the handle 1. FIG. 7 shows that the head 4 and the movable member 7 can be both pivoted to locate the bit (not shown) connected to the driving end 72 at desired position. It is noted that the head 4 is pivotable in the room 3 when the pivotable member 7 is removed from the first connection portion 41. Therefore, the second connection portion 44 can be positioned to be co-axial with the handle 1.

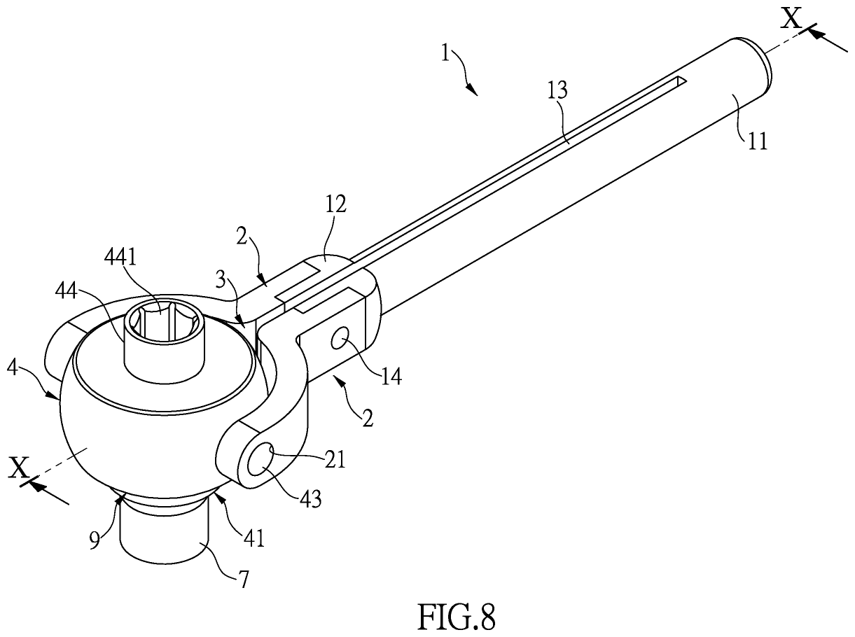

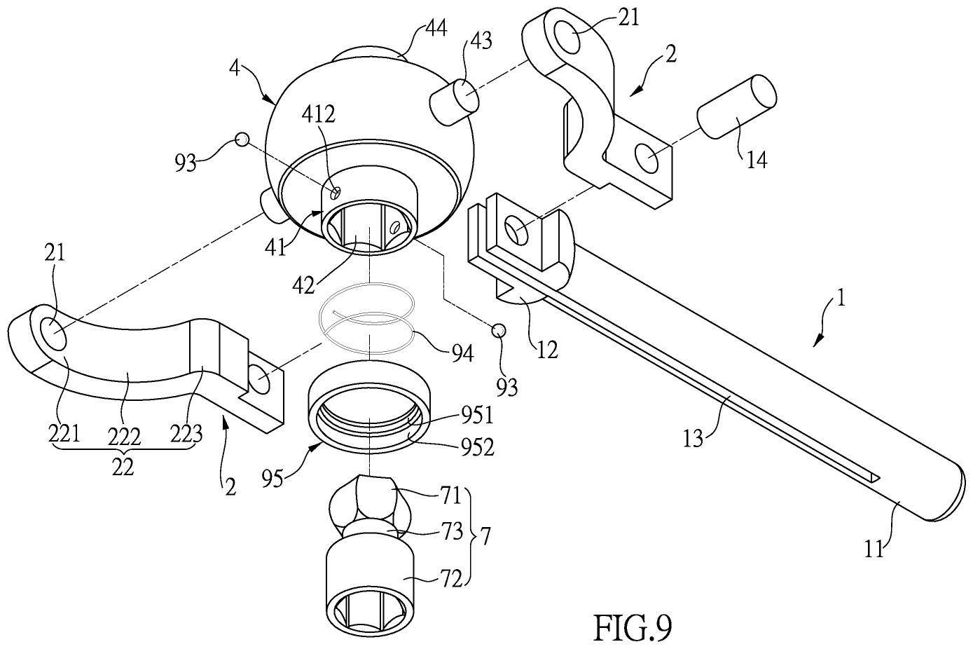

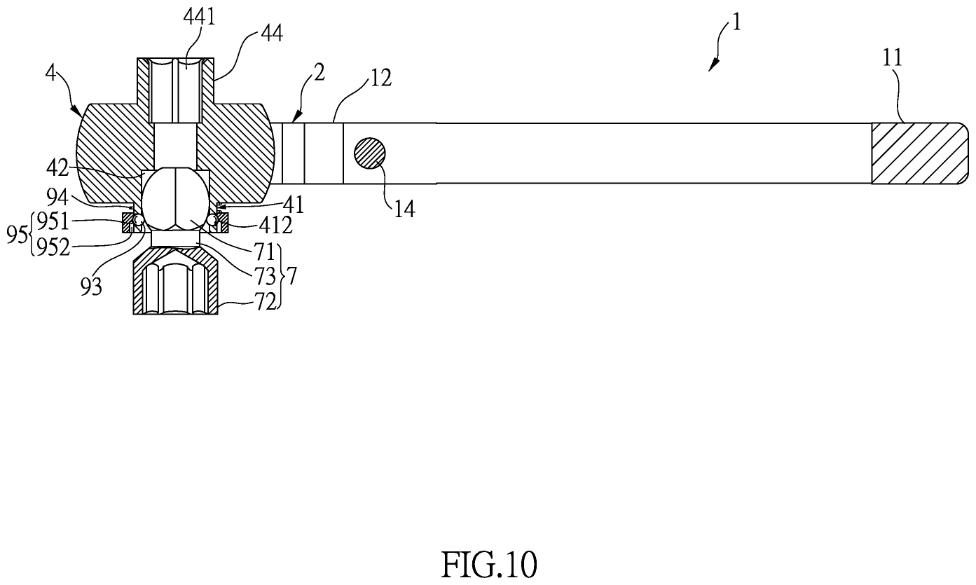

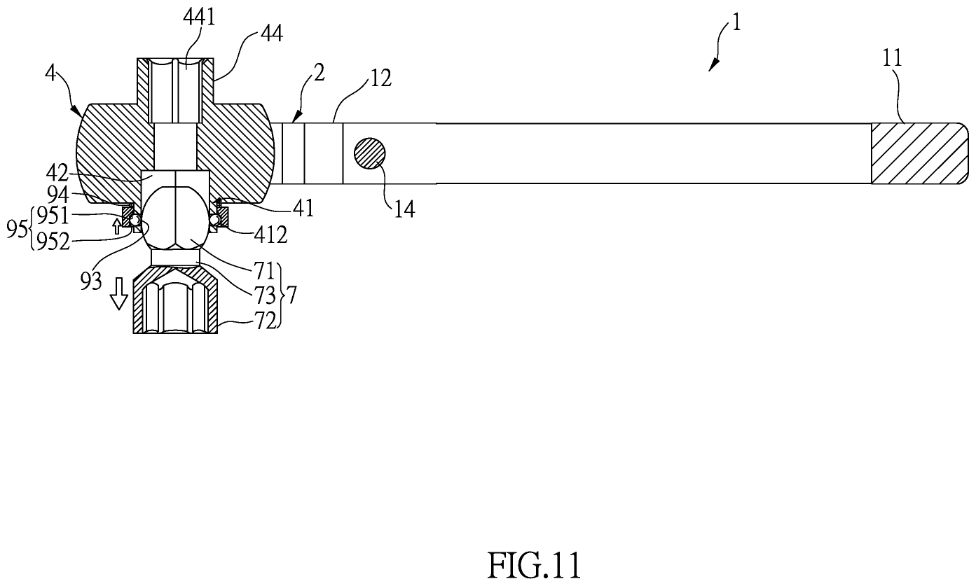

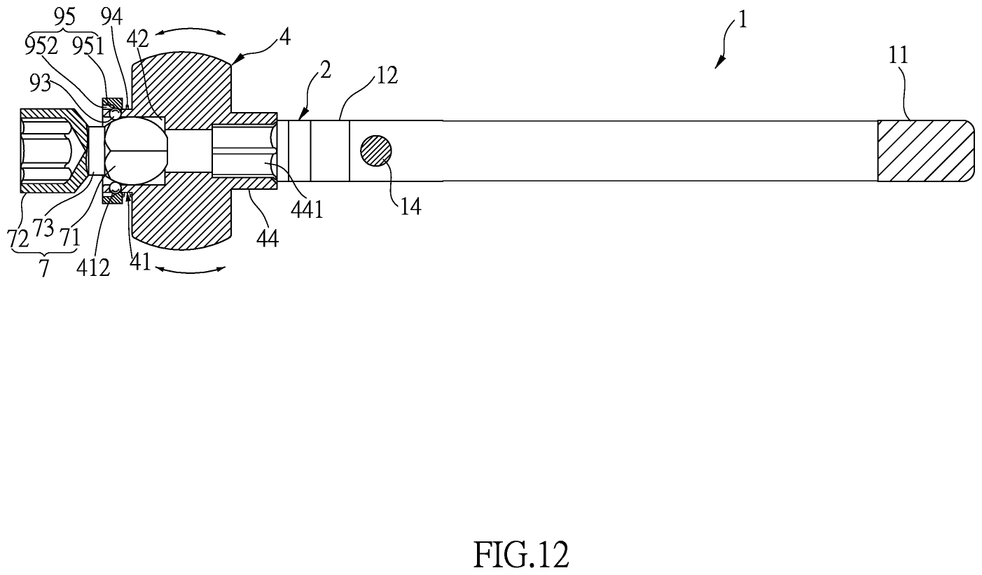

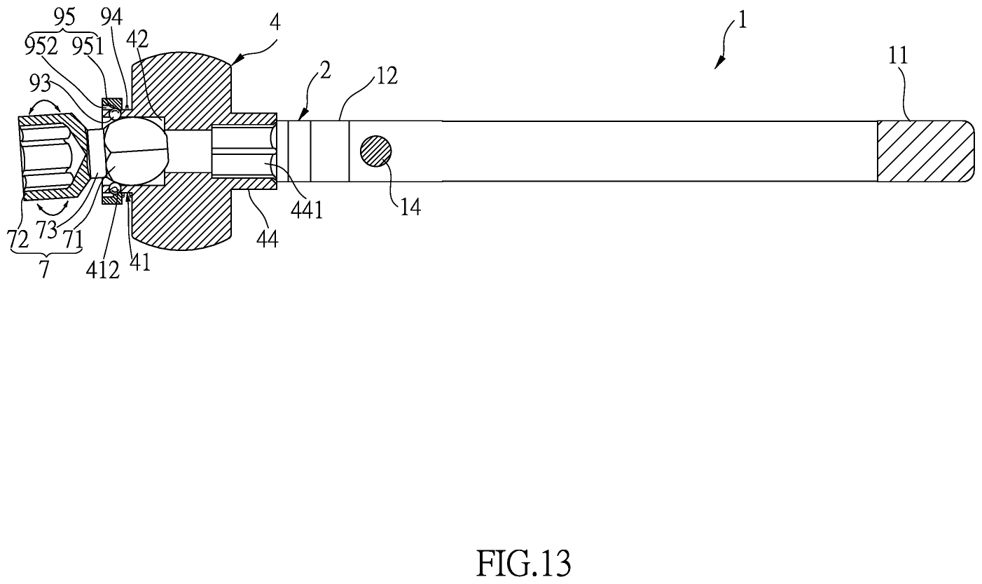

FIGS. 8 to 13 illustrate the second embodiment of the present invention, in this second embodiment, the control unit 9 includes at least one second ball 93, a spring 94 and a collar 95. The collar 95 is movably mounted to outside of the first connection portion 41, and the spring 94 is biased between the first connection portion 41 and the collar 95. The collar 95 includes a ridge 951 protruding from the inner periphery thereof. The ridge 951 preferably has a rounded or an inclined outer shape. A groove 952 is defined in the inner periphery of the collar 95. The first connection portion 41 includes at least one second hole 412 defined through the wall thereof, and the at least one second hole 412 communicates with the first reception hole 42. The at least one second ball 93 is engaged with the at least one second hole 412.

When the collar 95 is not yet moved along the first connection portion 41, the ridge 951 pushes the at least one second ball 93 so that the at least one second ball 93 has a portion protruding into the first reception hole 42. When the multiple-face part 71 is inserted into the first reception hole 42 and pushes the at least one second ball 93 outward, the at least one second ball 93 pushes the rounded or inclined outer shape of the ridge 951 so that the at least one second ball 93 slides into the groove 952 together with the collar 95 moving along the first connection portion 41, and the at least one second ball 93 is engaged with the groove 952. Of course, the movement of the collar 95 can also be moved by the user. The at least one second ball 93 is then engaged with the neck 73 when multiple-face part 71 passes the at least one second ball 93, and the spring 94 resiliently pushes the collar 95 back to force the ridge 951 to urge the at least one second ball 93 again. Therefore, the at least one second ball 93 is engaged with the neck 73 to position the movable member 7.

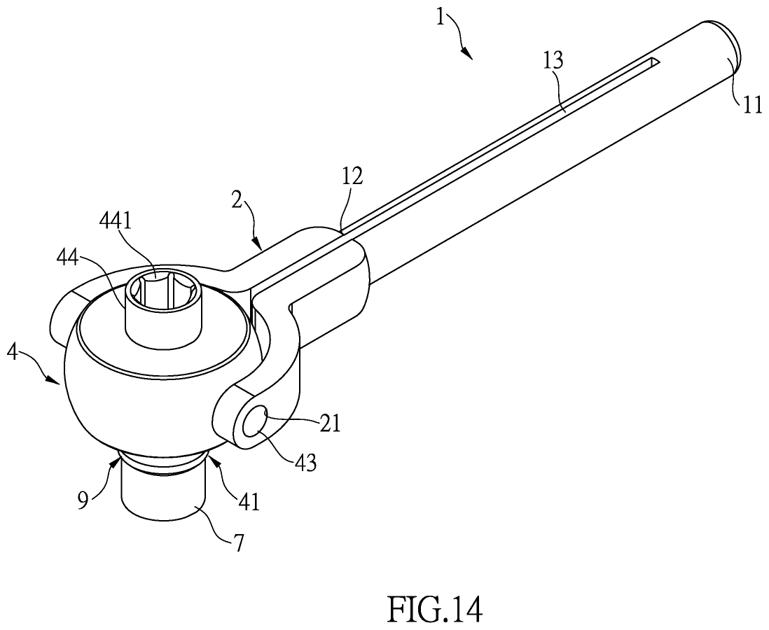

FIG. 14 shows that the two arms 2 can also be integral with the operation end 12 of the handle 1.

While we have shown and described the embodiment in accordance with the present invention, it should be clear to those skilled in the art that further embodiments may be made without departing from the scope of the present invention.

What is claimed is:

1. A ratchet wrench comprising:
a handle having a first end and a second end, two arms extending from the second end of the handle, a room formed between the two arms;
a head pivotably connected between the two arms and being pivotable relative to the two arms, the head having a first connection portion formed to a first side thereof, the first connection portion having a reception hole defined in a distal end thereof;
a pivotable member removably connected to the first connection portion and having a multiple-face part, a driving end and a neck which is formed between the multiple-face part and the driving end, the multiple-face part pivotably inserted into the reception hole so that the pivotable member is pivotable relative to the head, and
a control unit mounted to outside of the first connection portion and controlling engagement and removal of the multiple-face part relative to the reception hole.

2. The ratchet wrench as claimed in claim 1, wherein the control unit includes a first ball and an expandable member, the expandable member is a C-shaped member and includes a restriction hole defined through a wall thereof, an opening formed between two distal ends of the expandable member, the first connection portion includes a first hole defined through a wall thereof and communicating with the first reception hole, the first hole is located corresponding to the restriction hole, the first ball is engaged with the first hole and has a portion protruding beyond the first hole, the portion of the first ball that protrudes beyond the first hole is pushed by a periphery of the restriction hole to partially protrude into the first reception hole, when the multiple-face part is inserted into the first reception hole, the first ball is pushed by the multiple-face part to expand the expandable member, the first ball is engaged with the neck when multiple-face part passes the first ball.

3. The ratchet wrench as claimed in claim 1, wherein the control unit includes at least one second ball, a spring and a collar, the collar is movably mounted to outside of the first connection portion, the spring is biased between the first connection portion and the collar, the collar includes a ridge protruding from an inner periphery thereof, a groove is defined in the inner periphery of the collar, the first connection portion includes at least one second hole defined through a wall thereof and communicating with the first reception hole, the at least one second ball is engaged with the at least one second hole, when the collar is not yet moved along the first connection portion, the ridge pushes the at least one second ball so that the at least one second ball has a portion protruding into the first reception hole, when the multiple-face part is inserted into the first reception hole and pushes the at least one second ball, the at least one second ball pushes the ridge away from the at least one second ball together with the collar moving along the first connection portion, and the at least one second ball is engaged with the groove, the at least one second ball is engaged with the neck when multiple-face part passes the at least one second ball, the spring resiliently pushes the collar back and the ridge pushes the at least one second ball.

4. The ratchet wrench as claimed in claim 1, wherein the handle has a grip end formed to the first end thereof, the second end of the handle is an operation end, the two arms are integrally formed to the operation end, a slot is defined axially in the operation end and communicating through a distal end of the operation end.

5. The ratchet wrench as claimed in claim 1, wherein the handle has a grip end formed to the first end thereof, the second end of the handle is an operation end, a slot is defined axially in the operation end and communicating through a distal end of the operation end, a pin extends transversely through the two arms and the operation end.

6. The ratchet wrench as claimed in claim 4, wherein the head includes a second connection portion formed to a second side of the head, the second connection portion is located opposite to the first connection portion, the second connection portion has a second reception hole, the head is pivotable in the room and the second connection portion does not hit the arms when the pivotable member is removed from the first connection portion.

7. The ratchet wrench as claimed in claim 5, wherein the head includes a second connection portion formed to a second side of the head, the second connection portion is located opposite to the first connection portion, the second connection portion has a second reception hole, the head is pivotable in the room and the second connection portion does not hit the arms when the pivotable member is removed from the first connection portion.
